(19) United States
(12) Patent Application Publication
(10) Pub. No.: US 2011/0149109 A1
(43) Pub. Date: Jun. 23, 2011

(54) APPARATUS AND METHOD FOR CONVERTING COLOR OF TAKEN IMAGE

(75) Inventors: Maeng-Sub CHO, Daejeon (KR); Jin-Seo Kim, Daejeon (KR); Bonki Koo, Daejeon (KR); Soon-Young Kwon, Daegu (KR); Juyeon You, Daegu (KR); Ki-Hong Kim, Daejeon (KR)

(73) Assignee: Electronics and Telecommunications Research Institute, Daejeon (KR)

(21) Appl. No.: 12/963,587

(22) Filed: Dec. 8, 2010

(30) Foreign Application Priority Data
Dec. 21, 2009 (KR) 10-2009-0128484

(51) Int. Cl. H04N 9/73

(52) U.S. Cl. 348/223.1; 348/E09.051

(57) ABSTRACT

A method for correcting color of an action image taken together with a reference image having a color reference plate includes activating a predetermined correction window for correction of the action image; displaying the action image and at least one correction window for color correction of the action image on the correction window; creating a lookup table, when at least one is selected from references displayed on the correction window, for converting respective pixels in conformity with the selected data; and correcting color of the action image using the created lookup table.

### CROSS-REFERENCE TO RELATED APPLICATIONS

The present application claims priority of Korean Patent Application No. 10-2009-0128484, filed on Dec. 21, 2009, which is incorporated herein by reference in its entirety.

### BACKGROUND OF THE INVENTION

1. Field of the Invention

Exemplary embodiments of the present invention relate to an apparatus and a method for converting color; and, more particularly, to an apparatus and a method for converting the color of a taken image.

2. Description of Related Art

In general, digital cameras are widely used to take images, which are commonly corrected by various methods. Specifically, various programs based on PCs can be used to correct images, which have been taken by digital cameras, as desired by users.

Meanwhile, various digital technologies are combined and used in the film industry, such as the use of digital cameras for filmmaking, special effects based on computers, etc.

As known in the art, it usually takes months, or even years, to make a film in various manners. A number of scenes, cuts, etc., which are obtained during shooting, are edited and combined to complete a film. It is to be noted, however, that even if the same camera is used to take images of the same or similar scenes or cuts under the same illuminant, the time-varying intensity of sunlight may give different impressions to the resulting images, which may even be tainted against the director's intention.

Similar problems may occur as well in the case of taking images for TV programs or CFs. This means that film directors, CF directors, or TV producers are often made to correct taken images. Specifically, color images taken by cameras during filmmaking, CF-making, or TV program production are, if correction is needed, stored in computers at the studio and then subjected to color correction in the editing process.

However, such color correction is solely based on the naked eye of respective directors, which gives making accurate color corrections difficult. Furthermore, respective taken images contain information regarding scenes indicated on the clapperboard at the shooting spot, but contain no color information which can be used later as a reference for color correction. Such a lack of reference color information means that, during a following process of correcting the color of taken images, they may be given colors completely irrelevant to those of images taken by other cameras, due to difference of illuminant environments of the shooting spot or color characteristics of the cameras.

Handing these issues involves the following problem: Firstly, correction of respective taken images solely based on the visual sense of directors requires a large amount of manual labor. Secondly, it is impossible to accurately reproduce colors conforming to different illumination environments of the shooting spot or color characteristics of cameras.

### SUMMARY OF THE INVENTION

An embodiment of the present invention is directed to a system for easily converting the color of a taken image to as desired, and a method for controlling the same.

Another embodiment of the present invention is directed to a system for accurately correcting the color of a taken image as desired, and a method for controlling the same.

Another embodiment of the present invention is directed to a system for correcting the color of images taken by cameras having different characteristics in such a manner that, as a result of the correction, the images look as if they have been taken by cameras having the same characteristics.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for converting color of a taken image includes: an image separation unit configured to receive a reference image containing a color table and an action image, and separate the reference image and the action image; a color data extraction unit configured to output color values of the color table contained in the reference image; a display unit configured to display the action image, the reference image, and color correction information regarding respective images; a control unit configured to detect a change value by comparing color values contained in the reference image with color values contained in an original color table, control display of correction information displayed on the display unit, receive image color conversion information inputted by a user from the information displayed on the display unit, and create a lookup table for conversion to color selected by the user; and an image conversion unit configured to convert color by performing coordinate conversion of each color of the action image pixel by pixel using the lookup table.

In accordance with another embodiment of the present invention, a method for correcting color of an action image taken together with a reference image having a color reference plate includes: activating a predetermined correction window for correction of the action image; displaying the action image and at least one correction window for color correction of the action image on the correction window; creating a lookup table, when at least one is selected from references displayed on the correction window, for converting respective pixels in conformity with the selected data; and correcting color of the action image using the created lookup table.

### BRIEF DESCRIPTION OF THE DRAWINGS

FIG. 1 illustrates a conventional clapperboard commonly used for shooting to make a movie, CF, or TV program.

FIG. 2 illustrates a clapperboard in accordance with an embodiment of the present invention.

FIG. 3 illustrates a color table in accordance with the present invention.

FIG. 4 illustrates a three-dimensional lookup table for a color conversion table in accordance with the present invention.

FIG. 5 illustrates an example of mapping the color table of FIG. 3 onto the three-dimensional lookup table of FIG. 4.

FIG. 6 illustrates the construction of function blocks of a system for converting the color of taken images in accordance with an embodiment of the present invention.

FIG. 7 is a flowchart illustrating control of image correction in accordance with an embodiment of the present invention.

FIGS. 8A to 8D illustrate exemplary image correction windows for image correction.

FIG. 9 illustrates the construction of a system for color conversion in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The gist of the present invention will now be described. In accordance with the present invention, images are taken using a clapperboard having a color reference plate, based on which the color of taken images is later corrected using a computer, for example. The color correction in accordance with the present invention is applicable to images taken by different digital cameras, by different analog cameras, or by both digital and analog cameras.

A correction system in accordance with the present invention is configured to perform the following operations:

Firstly, the color of images taken together with a color reference plate is converted in conformity with illumination environments, which is desired by the user, using color information obtained from the color reference plate under specific illumination conditions.

Secondly, considering the fact that color characteristics depend on the manufacturer or model of cameras, the color of images taken by a specific camera is converted to color of images conforming to color characteristics of a desired camera.

Thirdly, the color of images taken together with a color reference plate is converted to a color desired by the director or producer by adjusting the hue, lightness, and chroma.

Fourthly, the color of an image taken at time B is automatically converted into the color of an image taken at time A.

In accordance with the present invention, as mentioned above, at start of every scene shooting, the clapperboard and the color reference plate are filmed first, and then the action scenes filmed. Taken images are stored in computers at the studio. Specifically, the images are separately stored as color reference plate images and action images. The color reference images and action images, which have been separately stored, are displayed on the monitor screen. Color data is then extracted from the reference plate image unit.

The difference between the taken color reference plate images and pre-stored reference colors is obtained, and the user input desired color information. Then the color data is converted into L*a*b color space, which is a standard color space of CIE (Commission Internationale de l'Eclairage), and a three-dimensional lookup table is created with regard to the converted data. The created lookup table is applied to action images, which are stored in the action image storage unit, to perform coordinate conversion. The coordinate-converted images are stored in the converted-image storage unit as color converted desired by the user.

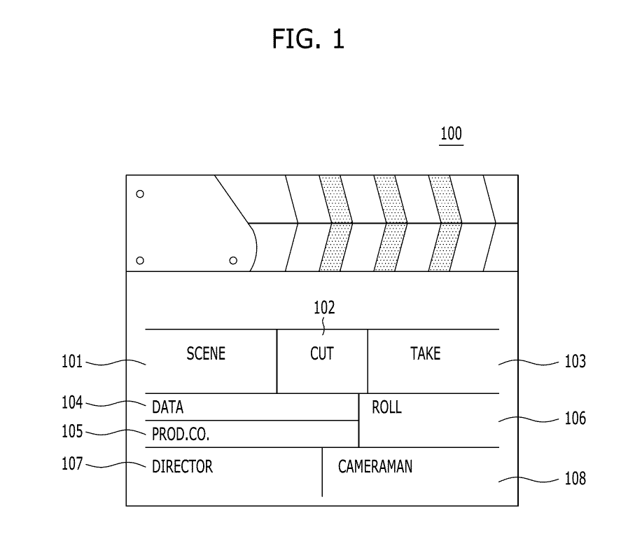

A conventional clapperboard commonly used for shooting to make a movie, CF, or TV program will now be described with reference to FIG. 1.

Referring to FIG. 1, the clapperboard 100 includes an area 101 for describing the scene number, an area 102 for describing the cut number, an area 103 for describing the take, an area 104 for describing the date, an area 105 for describing the producer, an area 106 for describing the roll number, an area 107 for describing the director, and an area 108 for describing the cameraman. These areas are used to describe information necessary for shooting, and some of them may be omitted if necessary.

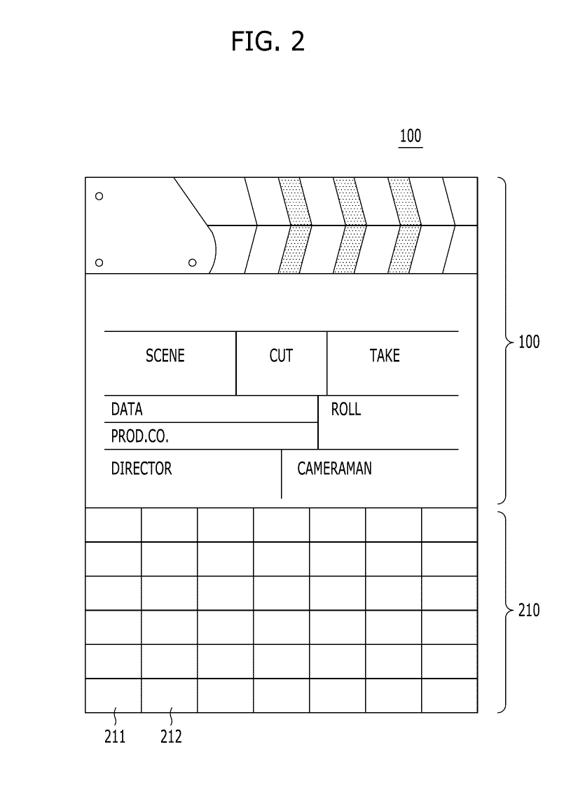

It is to be noted that the clapperboard 100 illustrated in FIG. 1 is not configured to enable recognition of colors, i.e. it has black and white colors only. This means that it is impossible to identify the degree of change of color, specifically lightness, chroma, hue, etc. due to illumination or camera characteristics. Considering this, the present invention proposes a clapperboard as illustrated in FIG. 2.

FIG. 2 illustrates a clapperboard in accordance with an embodiment of the present invention.

A clapperboard 200 in accordance with an embodiment of the present invention includes a conventional clapperboard 100 and a color plate 210 positioned beneath the clapperboard 100. The color plate 210 has a number of columns of reference colors, and each element 212 and 212 of the columns corresponds to a color. Those skilled in the art can understand that, although the clapperboard 200 illustrated in FIG. 2 has a color plate 210 positioned beneath the conventional clapperboard 100, the color plate 210 may be positioned on top of, to the left, or to the right of the conventional clapperboard 100. It is also possible to use a part of the margin of the conventional clapperboard 100 as the color plate 210, without deviating from the principle of the present invention that a color table is added to a conventional clapperboard 100.

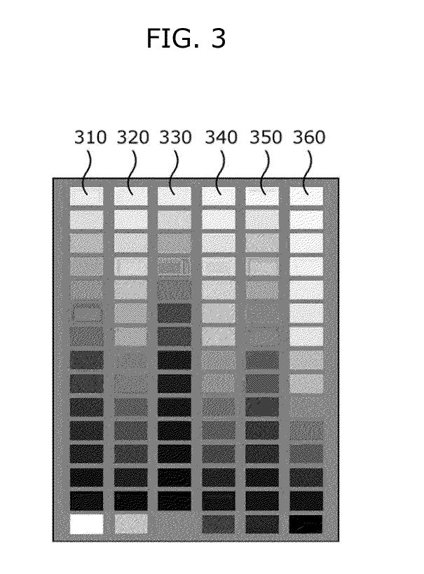

FIG. 3 illustrates a color table in accordance with the present invention.

Referring to FIG. 3, each column 310, 320, 330, 340, 350, and 360 corresponds to a series of predetermined list of colors. For example, the bottommost element of the first column 310 contains white color, and the bottommost element of the last column 360 contains black color. The first column 310 corresponds to a series of varying red colors; the second column 320 corresponds to a series of varying yellow-green colors; the third column 330 corresponds to a series of varying blue colors; the fourth column 340 corresponds to a series of varying sky-blue colors; the fifth column 350 corresponds to a series of varying purple colors; and the last column 360 corresponds to a series of varying yellow colors. This palette of colors is determined to include colors, the change of which due to illumination and camera characteristics is to be sensed by the system in accordance with the present invention. Therefore, the number of columns of the color conversion table is not limited to six, but can be varied as desired, together with the number of elements of each column.

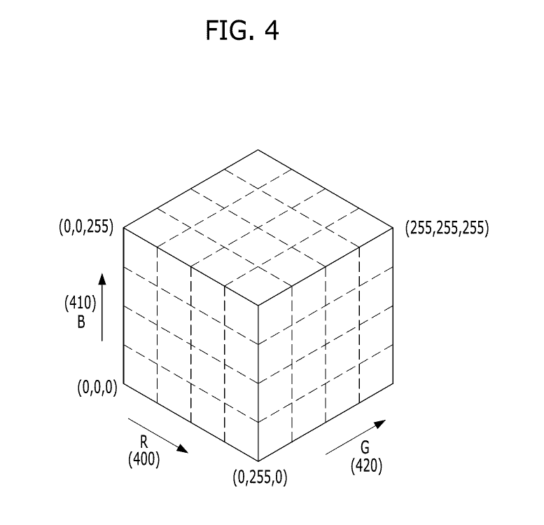

FIG. 4 illustrates a three-dimensional lookup table for a color conversion table in accordance with an embodiment of the present invention. In FIG. 4, reference numeral 400 indicates the direction of change of red colors, as labeled R below; reference numeral 410 indicates the direction of change of blue colors, as labeled B to the left; and reference numeral 420 indicates the direction of change of green colors, as labeled G below. Each coordinate of RGB (i.e. primary colors of light) corresponds to a degree of change of color.

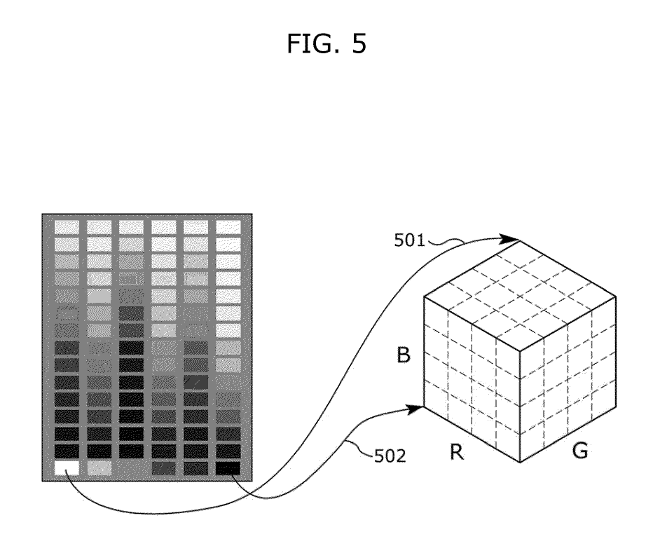

An example of measurement of degree of change of color using a coordinate will now be described with reference to FIG. 5.

FIG. 5 illustrates an example of mapping the color table of FIG. 3 onto the three-dimensional lookup table of FIG. 4.

Colors of the above-mentioned color table of FIG. 3 can be respectively mapped onto the three-dimensional lookup table described with reference to FIG. 4. This will be described in more detail using coordinates not described with reference to FIG. 4. Coordinate (0,0,0) in FIG. 4 corresponds to black color, which is mapped as indicated by reference numeral 502 in FIG. 5. This corresponds to a case in which no RGB values exist in FIG. 4. When all RGB values exist, i.e. coordinate (255,255,255) in FIG. 4 corresponds to white color, which can be coordinate-converted as indicated by reference numeral 501. As such, each color shown in FIG. 3 has specific RGB values, and can be mapped onto a coordinate of FIG. 4.

Each axis of FIG. 4 includes 256 coordinates, which correspond to 2⁸, in terms of binary digits, for easy detection of digital change. The number of coordinates can be varied if necessary.

The construction of a system for color conversion of taken images in accordance with an embodiment of the present invention will now be described with reference to the accompanying drawings.

It is to be noted that images in accordance with the present invention include images of scenes taken using a clapperboard 200 in accordance with the present invention, which has a color table as described above.

Images taken by cameras, which include a leading image of a clapperboard 200 having a color table in accordance with the present invention, are inputted to a color characteristic application unit 601. The color characteristic application unit 601 is configured to convert color characteristics in conformity with characteristics of the equipment used to take images or in conformity with characteristics of a camera other than the presently used equipment. Conversion of color images by the color characteristic application unit 601 in conformity with specific characteristics may be applied to all images, or applied in such a manner that the initially inputted image has no characteristics. The color characteristic application unit 601 may receive a value for correcting color images so that the accurate color is expressed according to the characteristics of the monitor displaying the inputted images. Specifically, a value for correcting the degree of change of a specific color in conformity with characteristics of the monitor can be set in advance. As such, the color characteristic application unit 601 can apply, before output, a color correction value conforming to color characteristics of the imaging equipment and/or characteristics of the monitor.

Images that have either undergone the above-mentioned color correction by the color characteristic application unit 601 or not are inputted to an image separation unit 602. The image separation unit 602 is configured to distinguish between images taken of the clapperboard 200 in accordance with the present invention and images actually needed. Separation by the image separation unit 602 may be performed mechanically. Alternatively, the user may separate the images while successively reviewing the images displayed on the screen. In the case of automatic separation, for example, the degree of change of images is used to distinguish between images having a predetermined shape (e.g. clapperboard in accordance with the present invention) for a predetermined period of time (e.g. first 2-10 seconds) and images having no predetermined shape and separately output the images. As such, images are separated by the image separation unit 602 into action images, which are used to make a film, CF, or TV program, and reference images of the clapperboard 200 in accordance with the present invention. Hereinafter, the images to be used to make a film, CF, or TV program will be referred to as action images, and images of the clapperboard 200 in accordance with the present invention will be referred to as reference images.

After separation by the image separation unit 602 in accordance with the present invention, reference images are inputted to a color data extraction unit 604, and action images are inputted into a first memory 605.

The action images separated by the image separation unit 602 are inputted to the first memory 605. Specifically, at least two action images may be stored. Each image may have been taken by the same camera, or by different cameras. One or at least two of the images stored in the first memory 605 may be displayed by a display unit 603 under the control of a control unit 611 (described later).

The color data extraction unit 604 is configured to convert color information of the color plate 210, which is included in the clapperboard 200 in accordance with the present invention, in the reference images into a digital value, as described with reference to FIGS. 3 to 5, and provides the control unit 611 with the digital value. When different images are successively inputted, i.e. when images have been taken at different times or by different cameras, respective images have the color plate 210 of the clapperboard 200 in accordance with the present invention. Then, color information of each color plate 210 is extracted, converted into a digital value as described above, and transferred to the control unit 611.

The display unit 603 is configured to display images received from the first memory 605 or action images inputted from the image separation unit 602.

The color memory 612 contains reference color information of the color plate 210 included in the clapperboard 200 in accordance with the present invention. It will be assumed in the following description that the reference color information refers to information obtained by mapping color information of the color plate in the process described with reference to FIGS. 3 to 5. In other words, the reference color information refers to information regarding the original color, not the color of images taken by cameras under some illumination, etc. The color memory 612 further includes an area for storing a lookup table for color conversion created by the control unit 611.

The input unit 613 is an input interface device for the user, and may be a keyboard, a mouse, a joystick, a touch screen, or any other type of device enabling the user to input desired information.

The control unit 611 is configured to control the color conversion of images stored in the first memory 605 based on information inputted from the input unit 613. Specifically, when the color data extraction unit 604 provides digital information regarding each color of the color plate 210 included in the clapperboard 200, the control unit 611 checks the degree of change in connection with a reference value inputted from the color memory 612. When a color change value based on a condition desired by the user is additionally inputted, the control unit 611 applies a conversion value regarding it and creates a lookup table for color conversion.

Creation of a lookup table by the control unit 611 will be described in more detail. Color conversion has a three-dimensional color conversion value as described with reference to FIGS. 3 to 5. A calculation process for coordinate conversion of images using a lookup table created in CIE L*a*b color space will now be described in detail.

A lookup table used for coordinate conversion may have a difference between the scale of L* axis and that of a*b* axes to improve the accuracy regarding the gray scale. Alternatively, the same scale may be applied for all of the three axes L*, a*, b* to create a lookup table.

A lookup table created by the control unit 611 in this manner can be stored in the color memory 612, and is provided to the image conversion unit 606.

The image conversion unit 606 is configured to convert the color coordinate of action images stored in the first memory 605 based on the lookup table received from the control unit 611 so that the color is converted as desired.

The operation of the image conversion unit 606 will now be described in more detail. The image conversion unit 606 reads RGB information of successive pixels of action images, which are stored in the first memory 605, and calculates the position on the lookup table, which corresponds to the RGB value of the pixels, using trilinear interpolation. The image conversion unit 606 refers to the lookup table, which has been created from measured-color data, to read the CIE L*a*b* value stored in the position on the lookup table, which corresponds to the RGB value of pixels of action images calculated in the above manner. Regarding the CIE L*a*b value read from the lookup table, color space conversion to a RGB color value used by the monitor is performed.

The above-described process is performed with regard to all pixels of inputted images. This completes coordinate conversion regarding taken images.

Images converted by the image conversion unit 606 are stored in a converted-image storage unit 607.

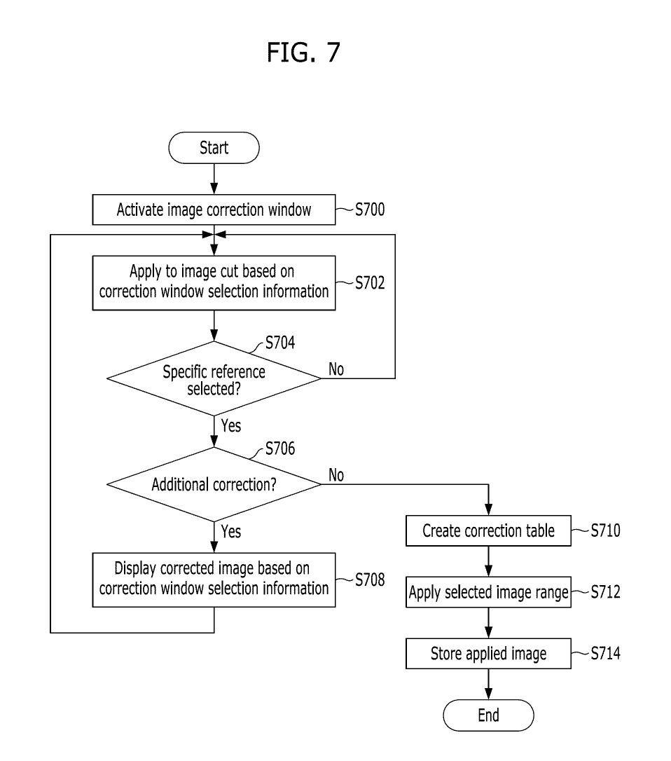

FIG. 7 is a control flowchart illustrating color correction of images in accordance with an embodiment of the present invention.

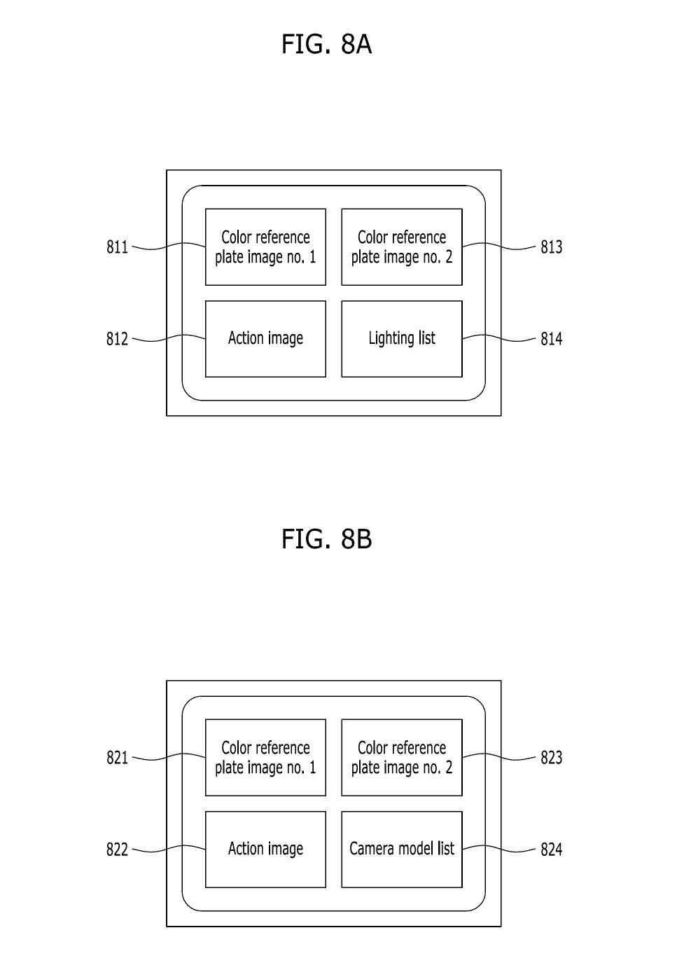

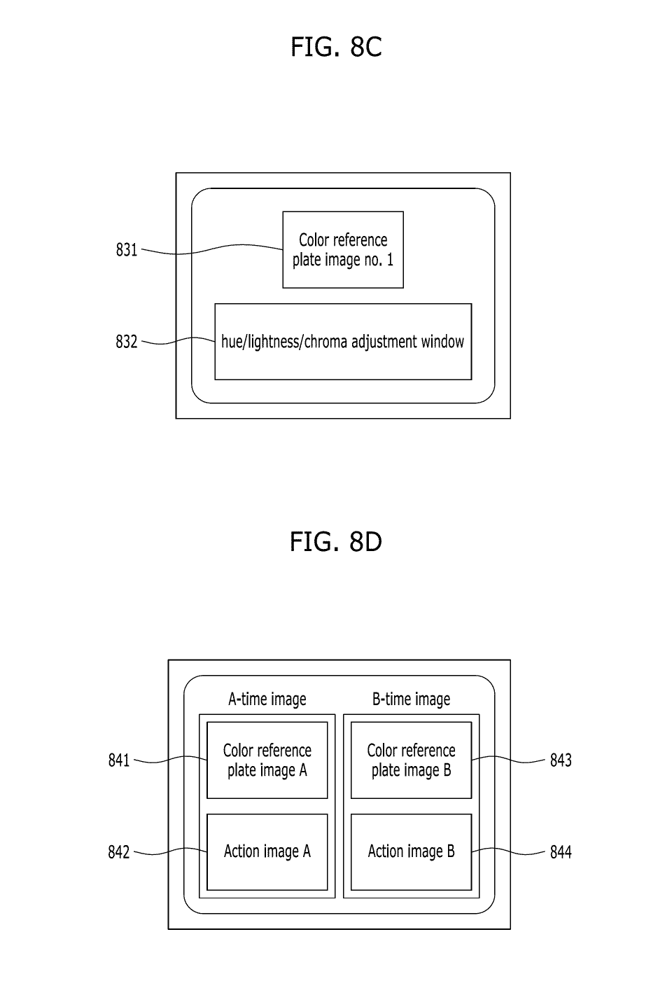

The control unit 611 activates an image color correction window at step S700. The image color correction window may have various shapes, as illustrated in FIGS. 8A to 8D, which are only examples to help understanding of the present invention, and do not limit the present invention. That is, the image color correction window may have any shape as long as a reference plate in accordance with the present invention is used, color change information is acquired from images of the reference plate, and the color of images is converted based on the acquired change information and user request information.

FIGS. 8A to 8D illustrate exemplary image color correction windows for correcting the color of images. Referring to FIG. 8A, the user display interface area is divided into four areas, specifically, an area 811 for displaying color reference plate image no. 1, an area 812 for displaying an action image taken together with the color reference plate image no. 1, an area 813 for displaying color reference plate image no. 2, and an area 814 for displaying a lighting list. In the case of FIG. 8A, therefore, desired illuminant e.g. lighting source can be selected from the lighting list for each image so that artificial change of light to the action images converts their color.

More specifically, a color reference plate image no. 1 activation window 811 is displayed together with an action image activation window 812. A color reference plate image no. 2 activation window 813 can show the original colors of the color reference plate. The user then can select desired illuminant from the list of various illuminations, which is shown in the lighting list activation window 814, using the input unit 613. After the desired illumination is selected, the colors of the color reference plate, which is shown in the color reference plate image no. 2 activation window 813, can be changed in conformity with the selected illumination. When requested to apply the color, which has been applied to the color reference plate image no. 2 activation window 813, the control unit 611 creates a lookup table for color correction conforming to the illumination desired by the user, and provides the image conversion unit 606 with the lookup table, so that the image conversion unit 606 displays color-corrected images based on the lookup table. This process can be performed for each cut of the image, or frame by frame. It is also possible to perform other types of additional correction after the illumination has been selected.

Referring to FIG. 8B, the user display interface area is divided into four areas, specifically, an area 821 for displaying color reference plate image no. 1, an area 822 for displaying an action image, an area 823 for displaying color reference plate image no. 2, and an area 824 for displaying a camera model list. In the case of FIG. 8B, therefore, different camera models can be set for respective images so that the action images are artificially modified to have different camera characteristics.

More specifically, a color reference plate image no. 1 activation window 821 is displayed together with an action image activation window 822. A color reference plate image no. 2 activation window 823 can show the original colors of the color reference plate. The user then can select a desired camera model from the list of various camera models, which is shown in the camera model list activation window 824, using the input unit 613. After the desired camera model is selected, the colors of the color reference plate, which is shown in the color reference plate image no. 2 activation window 823, can be changed in conformity with the selected camera model. When requested to apply the color, which has been applied to the color reference plate image no. 2 activation window 823, the control unit 611 creates a lookup table for color correction conforming to the camera model desired by the user, and provides the image conversion unit 606 with the lookup table, so that the image conversion unit 606 displays color-corrected images based on the lookup table. This process can be performed for each cut of the image, or frame by frame. It is also possible to perform other types of additional correction after the camera model has been selected.

Referring to FIG. 8C, the user display interface area is divided into two areas, specifically an area 831 for displaying color reference plate image no. 1 and an area 832 for adjusting hue, lightness, and chroma. In the case of FIG. 8C, therefore, the hue, lightness, and chroma can be varied artificially using the degree of change of color of images taken of the color reference plate.

More specifically, the color reference plate image no. 1 activation window 831 shows the image of the color reference plate in accordance with the present invention, which has been taken together with the clapperboard before action images are taken. In the case of FIG. 8C, color of the color reference plate is directly converted, without other types of information as in the above-mentioned cases of FIGS. 8A and 8B. Therefore, the user can use the input unit 613 to modify the hue, lightness, and chroma of a specific color as desired through the hue/lightness/chroma adjustment activation window 814. After adjusting the hue, lightness, and chroma of a specific color, colors of the color reference plate can be changed through the color reference plate image no. 1 activation window 831. When requested to apply the color, which has been applied to the color reference plate image no. 1 activation window 831, the control unit 611 creates a lookup table for color correction desired by the user, and provides the image conversion unit 606 with the lookup table, so that the image conversion unit 606 displays color-corrected images based on the lookup table. This process can be performed for each cut of the image, or frame by frame. It is also possible to perform other types of additional correction after the hue, lightness, and chroma have been selected.

Referring to FIG. 8D, the user display interface area is divided into four areas. Specifically, left and right halves are used for images taken at times A and B, respectively. The left half for image taken at time A includes an area 841 for displaying color reference plate image A and an area 842 for displaying action image A. The right half for image taken at time B includes an area 843 for displaying color reference plate image B and an area 844 for displaying action image B.

More specifically, the configuration of FIG. 8D is applicable to a case in which a specific scene is filmed by different cameras, a case in which images are taken at different times as the story of a movie or drama develops, or a case in which the elapse of time requires color conversion of images taken by the same or different cameras.

In such cases, images taken by two different cameras need to be reviewed simultaneously through activation windows. Therefore, color reference plate image A and action image A, which have been taken together, are displayed through an activation window 841 and an activation window 842, which lie beneath it, respectively. Similarly, color reference plate image B and action image B, which have been taken together, are displayed through an activation window 843 and an activation window 844, which lie beneath it, respectively. The user then can select a specific reference plate through the input unit 613 to make a transition into a configuration illustrated in one of FIGS. 8A to 8C, or vice versa. The user can also designate an image as a reference and modify the other so that two color reference values coincide. An image selected as a reference will hereinafter be referred to as a reference image. Specifically, when A-time image is the reference image, all colors of B-time image are made to conform to A-time image. Similarly, when B-time image is the reference image, all colors of A-time image are made to conform to B-time image. When a selection is made, the control unit 611 creates a lookup table for correction, based on the color of an image desired by the user, of color of the other image, and provides the image conversion unit 606 with the lookup table, so that the image conversion unit 606 displays color-corrected images based on the lookup table. The above-mentioned process can be performed for each cut of the image, or frame by frame. This correction may be followed by another type of correction, which has been described above.

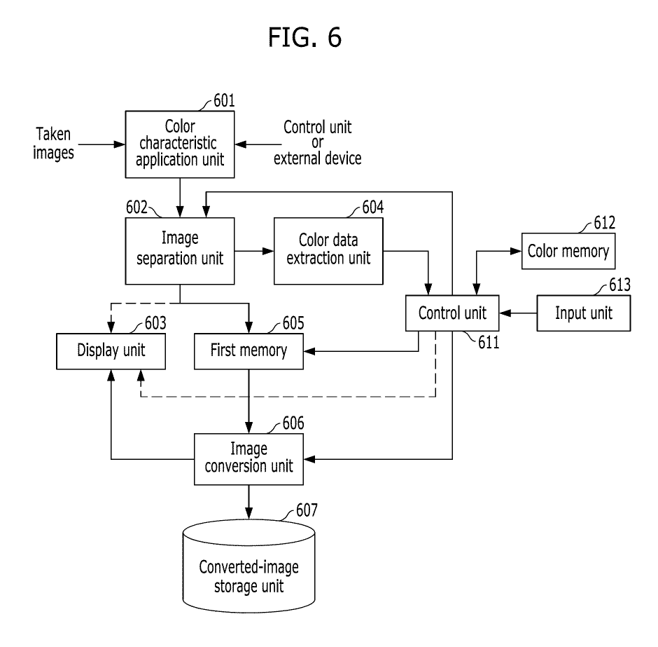

At least one of the above-mentioned modification methods of FIGS. 8A to 8D is applied in the system of FIG. 6.

Reference will now be made to FIG. 7.

The control unit 611 activates one of image correction windows illustrated in FIGS. 8A to 8D at step S700, and applies to an image cut based on information inputted by the user through the input unit 613 to display the image cut at step S702. When the user wants application to an image based on a specific reference during such display, i.e. when selection of a specific reference is completed at step S704, the control unit 611 creates a lookup table for primary conversion to selected colors. The control unit 611 proceeds to step S706 and confirms whether additional correction is to be performed or not. This is a process of confirming whether another type of correction illustrated in one of FIGS. 8A to 8D is to be performed or not. When further correction is need to be performed, the control unit 611 proceeds to step S708 and activates another correction window selected by the user based on correction window selection information (not shown), and repeats the step S702. When a lookup table has already been created in the previous process, the lookup table may be updated. Alternatively, another lookup table may be created.

When additional correction is completed, the control unit 611 proceeds to step S710, creates a coordinate conversion value to be applied to each pixel based on the currently applied correction information, and creates a lookup table for color correction. When a lookup table has been created each time a reference is selected, all lookup tables are combined into one. On the other hand, when the lookup table has been updated each time a reference is selected, a lookup table for correction is regarded as already having been created.

The control unit 611 determines the range of selected images based on the created lookup table. Specifically, the control unit 611 can set the range of images, which is to be applied equally to images stored for each scene or cut, or the time range of images of a specific scene.

The time range and image file range determined in this manner are applied to corresponding images, which are stored at step S714 with the completion of color conversion.

The present invention will now be summarized in the following:

At the start of every scene shooting, reference colors of the color reference plate are filmed, and action scenes are then filmed. The taken images are stored in computers at the studio. The color reference plate images and action images, which have been stored separately, are displayed on the monitor screen, and color conversion information is created based on conversion information desired by the user. Alternatively, with reference to color reference plate image A, which has been taken at time A, color information regarding change of color reference plate image B, which has been taken at time B, is created.

When a color reference plate image conforming to the selected color information is extracted from the color reference plate image database and displayed, the image is checked. Then, color data conforming to the color reference plate image is extracted from the measured-color data storage unit.

After the extraction from the measured-color data storage unit, a three-dimensional lookup table is created. Similarly, a three-dimensional lookup table is created regarding color data extracted from the reference plate image unit. Then, the CIE L*a*b value regarding the corresponding coordinate on both lookup tables is calculated for each pixel of the action image using trilinear interpolation.

The lookup table is created from plate image in the following manner: The average value of RGB is calculated for each patch of the measured-color data, and the calculated RGB value is converted into CIE L*a*b color space. The converted CIE L*a*b value is used to fill the lookup table as described with reference to FIG. 5. A value corresponding to a point of the lookup table is stored as L*a*b value regarding the patch.

Among the calculated values, CIE L*a*b values calculated using the lookup table created from the measured-color data storage unit are subjected to color space conversion to RGB values used by the monitor. This results in automatic conversion to colors desired by the user.

Conversion of color reference plate image A, which has been taken at time A, into color reference plate image B, which has been taken at time B, is as follows: A lookup table of measured-color data corresponding to each patch is retrieved with regard to the color patch image taken at time B. The position on the measured-color data lookup table, which corresponds to the RGB value of each pixel of the action image taken at time A, is calculated by trilinear interpolation. Then, the CIE L*a*b value stored in the corresponding position of the measured-color data lookup table, which corresponds to the patch taken at time B, is retrieved. The CIE L*a*b value retrieved from the lookup table is subjected to color space conversion to a RGB color value used by the monitor. The same process is repeated for every pixel of the inputted image. As a result, the color of the image taken at time A is converted to the same color of the image taken at time B, and the converted image is stored in the converted-image storage unit.

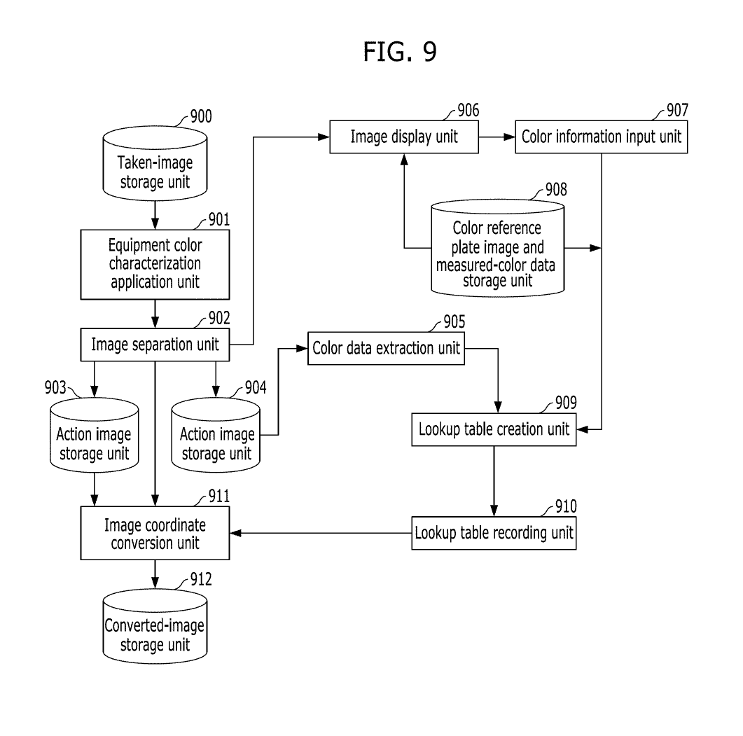

FIG. 9 illustrates the construction of a system for color conversion in accordance with another embodiment of the present invention.

Referring to FIG. 9, the taken-image storage unit 900 corresponds to the part of FIG. 6, to which taken images are inputted. The equipment color characterization application unit 901 corresponds to the color characteristic application unit 601 of FIG. 6. The image separation unit 902 corresponds to the image separation unit 602 of FIG. 6. The image separation unit 902 is configured to provide the action image storage unit 903, which is configured to store action images, with action images. The image separation unit 902 may include a reference plate image storage unit 904 configured to store reference plate images temporarily. The image display unit 906 corresponds to the display unit of FIG. 6. The color data extraction unit 905 of FIG. 9 corresponds to the color data extraction unit of FIG. 6. The color reference plate image and measured-color data storage unit 908 corresponds to the control unit 611 and color memory 612. The color information input unit 907 corresponds to the user input unit 613, and the lookup table creation unit 909 is regarded as a function block the control unit 611 of FIG. 6. The lookup table recording unit 910 corresponds to a partial area of the above-mentioned color memory 612. The image coordinate conversion unit 911 corresponds to the image conversion unit 606, and the converted-image storage unit 912 corresponds to the converted-image storage unit 607 of FIG. 6.

The above-mentioned correspondence is obvious from the system construction of FIG. 9, and further detailed description thereof will be omitted herein.

In accordance with the exemplary embodiments of the present invention, respective images taken by cameras can be corrected easily. Specifically, images taken at different times on different days can be corrected in such a manner that, as a result of the correction, the images look as if they have been taken on the same day. Furthermore, easy correction of respective images shortens time necessary for correction after shooting and reduces the cost for image correction.

While the present invention has been described with respect to the specific embodiments, it will be apparent to those skilled in the art that various changes and modifications may be made without departing from the spirit and scope of the invention as defined in the following claims.

What is claimed is:

1. An apparatus for converting color of a taken image, comprising:
an image separation unit configured to receive a reference image containing a color table and an action image and separate the reference image and the action image;
a color data extraction unit configured to output color values of the color table contained in the reference image;
a display unit configured to display the action image, the reference image, and color correction information regarding respective images;
a control unit configured to detect a change value by comparing color values contained in the reference image with color values contained in an original color table, control display of correction information displayed on the display unit, receive image color conversion information inputted by a user from the information displayed on the display unit, and create a lookup table for conversion to color selected by the user; and
an image conversion unit configured to convert color by performing coordinate conversion of each color of the action image pixel by pixel using the lookup table.

2. The apparatus of claim 1, wherein the image conversion unit is configured to provide the display unit with a color-converted image so that the image is displayed.

3. The apparatus of claim 1, wherein the control unit is configured to control the display unit so as to display the reference image, the action image, original color of the reference image, and a lighting list having pre-stored illuminant values and, when illumination is selected from the lighting list, create a mapping table for converting color of the action image so that the action image has the same color as when taken under the selected illumination.

4. The apparatus of claim 1, wherein the control unit is configured to control the display unit so as to display the reference image, the action image, original color of the reference image, and a camera list having pre-stored characteristics and, when a camera is selected from the camera list, create a mapping table for converting color of the action image so that the action image has the same color as when taken by the selected camera.

5. The apparatus of claim 1, wherein the control unit is configured to control the display unit so as to display the reference image and a list for adjusting hue, lightness, and chroma of the reference image and, when setup of the hue, lightness, and chroma is completed, create a mapping table for converting color of the reference image.

6. The apparatus of claim 1, wherein the control unit is configured to control display of at least two reference and action images taken at different times and, when requested to designate one of the reference images as a standard image and convert color of the other images, create a mapping table for converting color of other images to color of the standard image.

7. The apparatus of claim 1, further comprising:
a color characteristic application unit configured to correct, in advance, color of a taken image based on characteristics of a camera used to take the image or characteristics of display of the taken image and provide the image separation unit with the color-corrected image.

8. The apparatus of claim 1, further comprising:
a converted-image memory configured to store an image having color corrected by the image conversion unit.

9. A method for correcting color of an action image taken together with a reference image having a color reference plate, comprising:
activating a predetermined correction window for correction of the action image;
displaying the action image and at least one correction window for color correction of the action image on the correction window;
creating a lookup table, when at least one is selected from references displayed on the correction window, for converting respective pixels in conformity with the selected data; and
correcting color of the action image using the created lookup table.

10. The method of claim 9, wherein the correction window comprises at least two windows for displaying a reference image, an action image, a lighting list, a color reference plate image, a camera model list, hue/lightness/chroma, or an image taken a different time.

11. The method of claim 10, further comprising:
activating a correction window for additional correction when additional color correction is requested after the image correction; and
creating a lookup table, when at least one is selected from references of the activated correction window, for converting respective pixels in conformity with the selected data and correcting color of the action image.

12. The method of claim 11, wherein the lookup table created when additional correction is requested is a lookup table previously created and updated.

13. The method of claim 12, further comprising:
storing the lookup table.

14. The method of claim 10, further comprising:
storing the corrected image.

15. The method of claim 10, wherein color correction of the image is applied only to a predetermined image range.
